(19) United States
(12) Patent Application Publication
(10) Pub. No.: US 2008/0276324 A1
(43) Pub. Date: Nov. 6, 2008

(54) Encoding With Watermarking Prior to Phase Modulation

(75) Inventors: Minne Van Der Veen, Eindhoven (NL); Aweke Negash Lemma, Eindhoven (NL); Sylvain Pierre Beauget, Le Lamentin (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/911,122

(22) PCT Filed: Apr. 12, 2006
(86) PCT No.: PCT/IB06/51126

§ 371 Date: Oct. 10, 2007

(30) Foreign Application Priority Data
Apr. 13, 2005 (EP) 05102889.2

(51) Int. Cl. G11B 20/00

(52) U.S. Cl. 726/33

(57) ABSTRACT

In watermarking systems, hackers may try to remove the watermark using a so-called collusion attack. If the attacker has access to multiple identical signals with different watermarks (this typically occurs in electronic content delivery systems), simply averaging the signals will remove the watermark energy. A known solution to this problem is phase modulation. By modulating the phase of the signals, the averaging attack will cause phase cancellation to occur and annoying artifacts to be introduced. In the prior art, said phase modulation is carried out in the base-band domain, prior to watermark embedding. The present invention enables phase modification efficiently to be applied to transform coded signals, in particular DCT or MDCT coded signals such as MP3 or AAC audio signals, or MPEG2 video signals. The bitstream is partially decoded (4) and re-encoded (7). In accordance with the invention, the phase modification is now performed by an appropriately modified version of the forward or inverse (M)DCT transform algorithm (9). The phase modulation is thus an integral part of the decoding process (before watermark embedding) or the encoding process (after watermark embedding), which is very efficient. The phase modulation is controlled by parameters provided by a control function (5).

The present invention relates to a method and apparatus for decoding an encoded signal, to generate a decoded phase modulated signal. The invention also relates to a method for encoding a signal.

It is well known that it is desirable to limit a user's ability to make copies of digital data stored on digital media. This is particularly true of data representing music or video content which is protected by copyright laws. Copyright owners are keen to limit a user's ability to make copies of such content so as to protect revenues from legitimate sales.

One known method for controlling a user's ability to make copies of digital data such as that described above is to use digital watermarks. A digital watermark is embedded within digital data provided to a user, and is ordinarily invisible to the user. The watermark can however be detected by software configured to present the data to the user, and can thus be used to limit access to the data in various ways. Additionally, digital watermarks can be used as a means to prevent unauthorised copying.

Recently, some users have tried to remove watermarks from digital data so as to generate data which can be freely accessed and copied. Such removal of digital watermarks is clearly undesirable.

One known method for removing watermarks from digital signals is referred to as a “collusion attack”. Here, a user seeks to combine a plurality of signals including watermarks in an attempt to remove the watermarks. These signals can either comprise different source signals (e.g. different films) bearing the same watermark, or the same signal (e.g. the same film) bearing different watermarks (perhaps for different users). The collusion attack using two or more identical source signals with different watermarks operates by averaging the two or more signals to remove (or at least reduce) the watermark in the averaged signal.

Various methods are known for hindering a collusion attack operating on identical source signals having different watermarks. One such method is described in U.S. Pat. No. 6,145,081 (Winograd et al). Here, before embedding a watermark, the source signal is phase modulated using appropriate parameters. The parameters are selected such that the phase modulated signal is, in use, indistinguishable from the source signal. By using a plurality of different sets of parameters, a plurality of different phase modulated signals can be generated using a single source signal. The parameters are additionally selected such that phase cancellation and undesirable artefacts are generated when the averaging involved in a collusion attack of the type described above is carried out using differently phase modulated signals. This renders the obtained signal useless.

Although the method described in U.S. Pat. No. 6,145,081 effectively hinders a collusion attack, it is appropriate only for application to base band source signals. It cannot be applied directly for example to a bitstream signal, such as the many encoded signals which are currently in widespread use, such as MP3 audio, and AAC audio.

It is an object of embodiments of the present invention to obviate or mitigate at least some of the problems outlined above.

According to the present invention, there is provided a method and apparatus for decoding an encoded signal. The method comprises receiving the encoded signal, and decoding the received encoded signal to generate a phase modified decoded signal.

By decoding the received signal to produce a signal which is a phase modified version of a source signal represented by said encoded signal, the invention allows the benefits of phase modulation described above to be realised in connection with encoded signals, such as compressed domain signals.

Decoding may comprise decoding and transform domain modification of the received encoded signal. The decoding and transform domain modification are preferably carried out in an integrated operation. For example, the kernel of the decoding function is arranged to output phase modulated decoded signal values.

Efficiency is therefore greatly enhanced as phase modulation incurs only a minimal additional overhead given that it is effected by transform domain modification which is integrated with decoding of the encoded signal.

The method may further comprise, receiving a control signal, and using said control signal in the decoding. More particularly the control signal may be used to control transform domain modification of said received signal to form said phase modulated decoded signal. A plurality of different control signals may be generated using an appropriate control function. Each control signal may apply a different transform domain modification to the received signal. A plurality of decoded phase modulated signals, each being generated using a different control signal are preferably, in use, substantially indistinguishable. Additionally the plurality of decoded phase modulated signals, each generated using a different control signal, preferably cause phase cancellation when averaged.

The method may further comprise receiving digital bit stream data and processing said digital bit stream to generate said encoded signal. The processing may comprise dequantization.

The method may further comprise embedding watermark data in said phase modified decoded signal.

The decoding may comprise applying an inverse modified discrete cosine transform (IMDCT) to the received encoded signal.

The method may further comprise encoding said phase modified decoded signal to generate a modified encoded signal, such that a decoded version of said modified encoded signal is a phase modulated version of said modified decoded signal. A further control signal may be received, and the further control signal may be used in said encoding, for example to control modification of the encoded signal.

The phase modulated encoded signal may be processed to generate an output bit stream. This processing may comprise quantization.

The method set out above maybe used in combination with methods described in published international patent application WO2004/107316. That is, the decoder may generate intermediate data which is passed directly to an encoder in order to encode the signal with greater efficiency.

According to a further aspect of the present invention, there is provided a method for encoding a signal, comprising receiving said signal and encoding said received signal to generate a modified encoded signal, such that decoding of said modified encoded signal generates a phase modulated version of said signal.

The encoding preferably comprises encoding and modifying said received signal in an integrated operation. Phase modulation may be effected by modification of an encoding function. The received signal may include an embedded watermark. The encoding may comprise applying a modified discrete cosine transform to the received signal.

The method set out above may be implemented using an appropriately programmed computer. The invention further provides a computer readable medium carrying computer readable instructions to cause a computer to carry out any of the methods set out above.

The invention still further provides a computer apparatus for decoding and/or encoding, and phase modulating a signal. The computer apparatus comprises a program memory containing processor readable instructions, and a processor configured to read and execute instructions stored in said program memory. The processor readable instructions comprise instructions configured to cause the processor to carry out one of the methods set out above.

Embodiments of the present invention will now be described, by way of example, with reference to the accompanying drawings, in which:

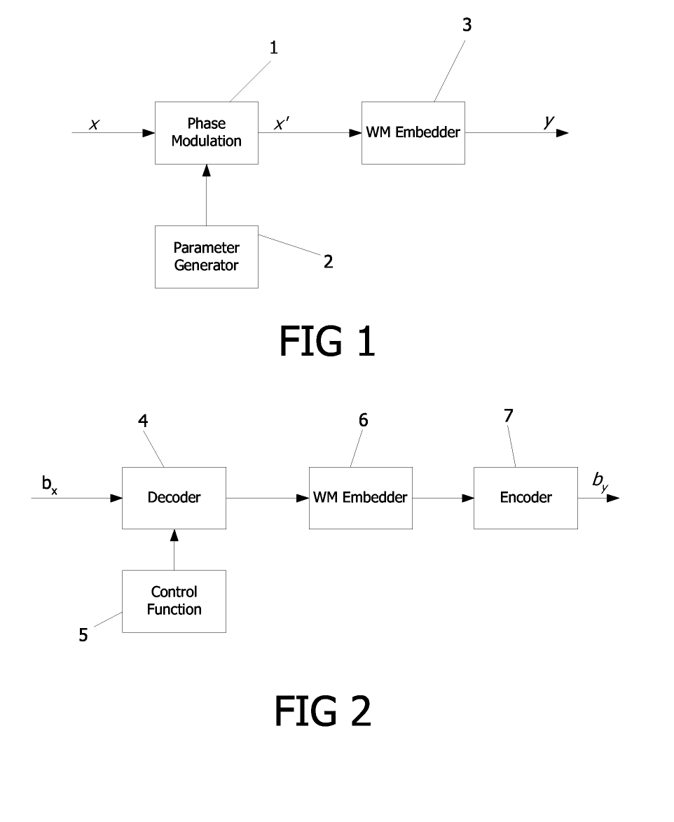

FIG. 1 is a schematic illustration of a prior art apparatus for embedding a watermark in a signal;

FIG. 2 is a schematic illustration of an apparatus for embedding a watermark in a signal in accordance with the present invention;

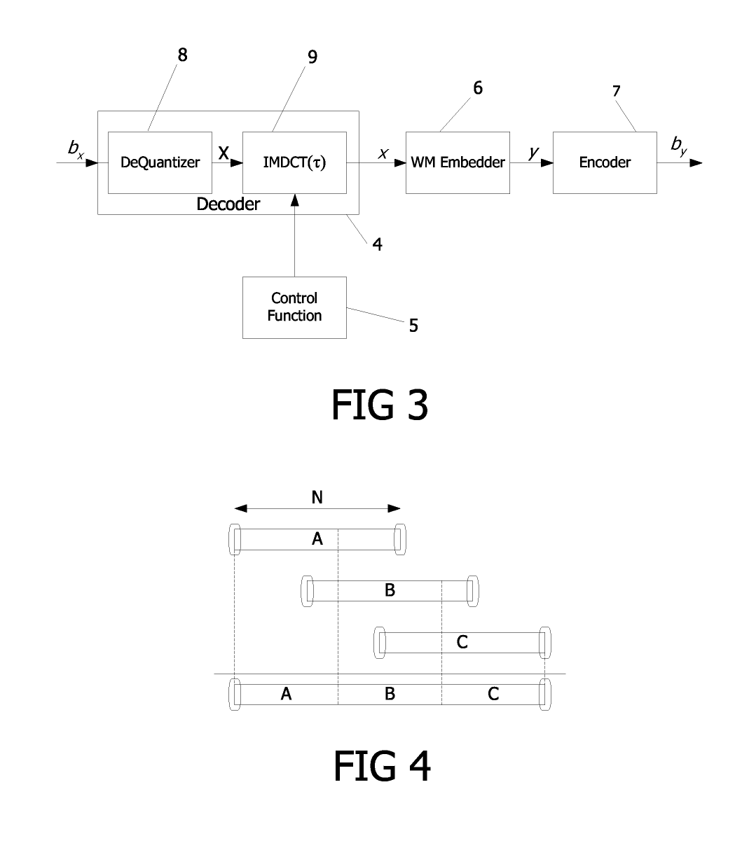

FIG. 3 is a schematic illustration of the apparatus of FIG. 2 in further detail;

FIG. 4 is a schematic illustration showing how frames of processed data are combined;

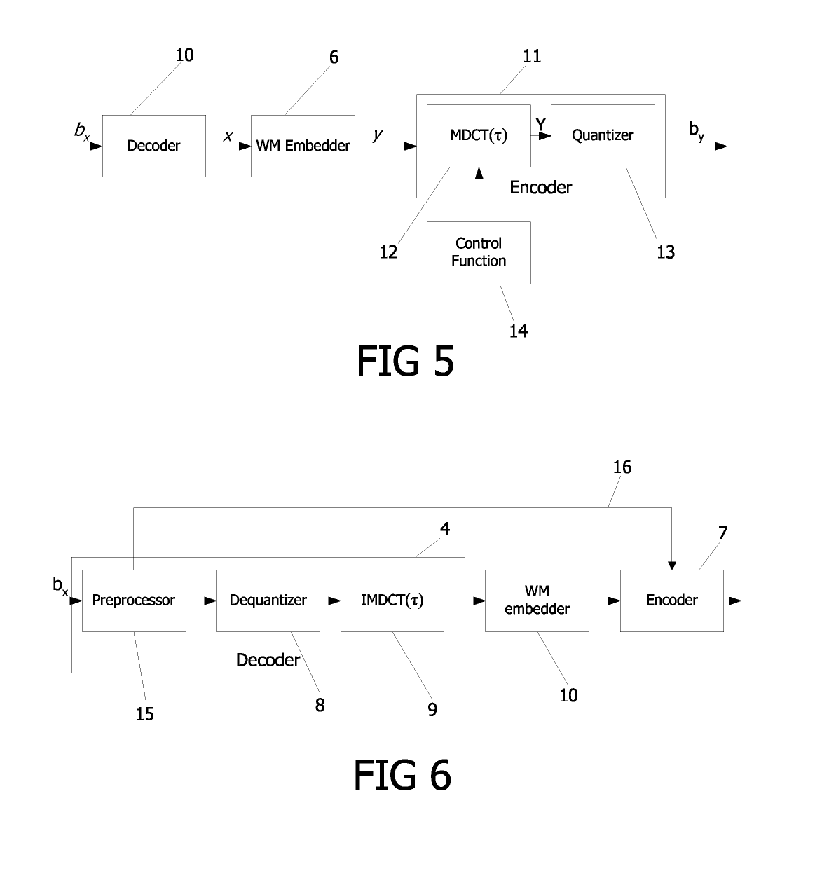

FIG. 5 is a schematic illustration of an alternative embodiment of the present invention;

FIG. 6 is a schematic illustration showing an alternative implementation of the apparatus of FIG. 2; and

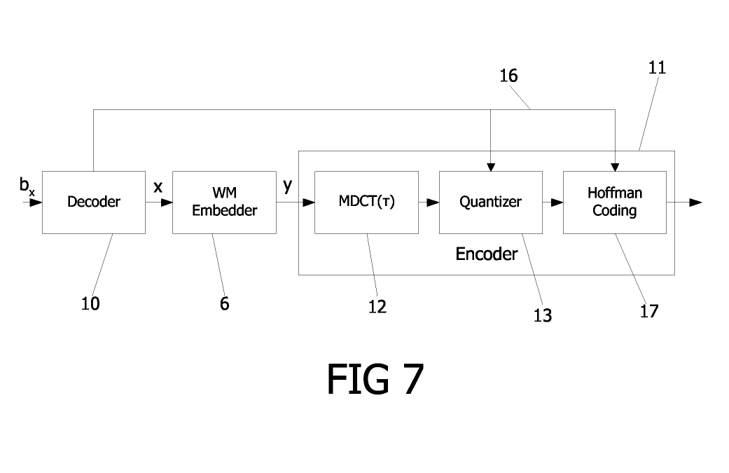

FIG. 7 is a schematic illustration of an alternative embodiment of the present invention based upon that illustrated in FIG. 5.

Referring first to FIG. 1, a known apparatus for embedding a watermark in a signal is illustrated. A source signal x is input to a phase modulation unit 1, the operation of which is controlled by parameters generated by a parameter generator 2. The phase modulation unit 1 phase modulates the source signal x in accordance with the parameters generated by the parameter generator, and a phase modulated signal x′ is output from the phase modulation unit 1.

The phase modulated signal x′ output by the phase modulation unit 1 is input to a watermark embedder 3 configured to embed a watermark within the phase modulated signal x′. The embedding of a watermark in a signal is a well known process in the art. An output signal y is output from the watermark embedder 3.

The parameter generator 2 is configured so as to generate a plurality of different sets of parameters for input to the phase modulation unit 1. This means that two identical source signals x may be phase modulated in different ways by the phase modulation unit 1, in dependence upon the parameters received from the parameter generator 2. The parameter generator is configured so as to generate parameters which are such that the phase modulation using the parameters will result in there being, in use, no perceptible difference between the source signal input to the phase modulation unit 1, and the signal output from the phase modulation unit 1. Thus, if the source signal x input to the phase modulation unit 1 is a sound signal the output signal x′ will sound, to a listener, identical to the input signal x.

However the parameter generator is also configured so as to generate a plurality of sets of parameters which are such that a phase modulated signals generated using different sets of parameters will, when combined together result in highly undesirable artefacts being obtained. Thus, a collusion attack attempting to remove a watermark from a signal will fail given that a plurality of identical source signals having different watermarks cannot be combined together so as to remove the watermark without greatly degrading the source signals.

FIG. 2 illustrates an apparatus in accordance with the present invention. The apparatus of FIG. 2 is concerned with embedding watermarks within encoded signals, such as compressed domains signals. The apparatus can be used in connection with any encoded signal including compressed domain format signals such as MPEG video, MP3 audio, or Advanced Audio Coding (AAC) audio. It will be readily apparent to one of ordinary skill in the art that the method is equally applicable to other encoded signals.

Referring to FIG. 2, an input digital bit stream signal b1 is input to a decoder 4, the decoder 4 being configured to decode the received bit stream to output a baseband signal. The decoder 4 receives a control signal generated by a control function 5. In addition to decoding the received signal bathe decoder 4 applies phase modulation to the received signal in accordance with the control signal generated by the control function 5. Thus, the signal output by the decoder 4 is both decoded and phase modulated, as will be described in further detail below.

The control function generator 5 operates so as to generate control signals which cause phase modulation such that any attempt to collude multiple signals in an attempt to remove a watermark will result in highly degraded content. Suitable control functions are described in further detail below.

The decoded phase modulated signal output by the decoder 4 is input to a watermark embedder 6 which is configured to embed watermark data within the signal. Embedding of watermarks within signals is well known in the art, and the process of embedding a watermark in a signal is therefore not described in further detail here. The watermark embedder 6 outputs the received signal additionally including a suitable watermark, and this signal is passed to an encoder 7 configured to encode the signal in an appropriate compressed domain format, so as to output a bit stream b_{y}.

In the described embodiment the decoder 4 operates using an Inverse Modified Discrete Cosine Transform (IMDCT), while the encoder 7 operates using a Modified Discrete Cosine Transform (MDCT). These transforms are well known in the art and are used to respectively decode and encode data in the AAC format.

FIG. 3 illustrates the apparatus shown in FIG. 2 in further detail. It can be seen that the decoder 4 comprises a dequantizer 8 and an IMDCT block 9. The watermark embedder 6 and the encoder 7 are as described above with reference to FIG. 2.

The dequantizer 8 takes the bit stream b, and outputs an MDCT coded signal X which is input to the IMDCT block 9. Operation of the dequantizer 8 will be well known to one of ordinary skill in the art, and is not described in further detail here.

The IMDCT is defined by equation (1):

$$x [ n ] = f [ n ] {\sum }_{k = 0}^{N / 2 - 1} X [ k ] cos ( \frac{π}{2 N} ( 2 n + 1 + \frac{N}{2} ) ( 2 k + 1 ) ) , \qquad ( 1 )$$

where:

n=0, . . . , N−1;

X[k] is the signal output from the dequantizer 8 and is defined for k=1, . . . , N/2 (i.e. the input encoded signal);

ƒ[n] is a window function such as, for example,

$$f [ n ] = sin ( π \frac{n}{N} ) ;$$

and

x is the signal output from the IMDCT.

The IMDCT as defined by equation (1) above is, in the apparatus of FIG. 3, modified so as to cause an phase modulated output time domain signal x to be generated. That is, the IMDCT block 9 of FIG. 3 operates in accordance with equation (2) set out below:

$$x [ n - τ [ n ] ] = f [ n - τ [ n ] ] {\sum }_{k = o}^{N / 2 - 1} X [ k ] cos ( \frac{π}{2 N} ( 2 n - 2 τ [ n ] + 1 + \frac{N}{2} ) ( 2 k + 1 ) ) \qquad ( 2 )$$

where:

n, X[k], and x are as defined with reference to equation (1); and

τ[n] is a control signal generated by the control function generator 5 and used to cause phase modulation of the output signal.

The control signal τ[n] is generated using a control function selected such that a phase modulated signal is in use indistinguishable or nearly indistinguishable from the source signal. Additionally, two differently phase modulated signals should, when combined, lead to maximum possible distortion, so as to prevent combination of signals to remove watermarks. One control function capable of achieving these aims is represented by equation (3):

τ[n]=δ+A sin(2πfₘn+φ) (3)

where:

δ is a constant delay;

A is the amplitude to be associated with the modulation;

fₘ is the frequency to be associated with the modulation; and

φ is the phase shift to be associated with the modulation;

The parameters A and fₘ in equation (3) are directly related to audio quality and must therefore be carefully selected. For example, applying modulation as represented by equation (3) to a sine wave with fundamental frequency f_{c} will introduce frequency components at positions f_{c}+n.fₘ, where the components are weighted in accordance with the Bessel functions. If fₘ is a low frequency (approximately 1 Hz), the energy added by the modulation process will be concentrated around f_{c} and in audio applications such energy will not be perceptible to a user.

Conversely, the parameter φ is simply a change to the starting point of the modulation, and therefore has no effect on audio quality. Thus, the parameter φ can be changed freely to generate differently phase modulated signals, without affecting audio quality. Differences between values of the parameter φ should however, be large enough to cause distortion when differently phase modulated signals are combined.

It can therefore be seen that the parameters δ, A, and fₘ will in general remain constant for all operations of the apparatus for FIG. 3, while the parameter φ will be varied so as to generate different control functions, causing different phase modulations.

Experiments have been carried out using the apparatus shown in FIG. 3. An audio signal having a sample frequency of 44.1 kHz was decoded using the decoder 4. The control function 5 was that of equation (3) and configured such that δ=0, A=5, and fₘ=1 Hz. φ was varied so as to provide varying control signals to cause different phase modulations. It was concluded that differences between values of the parameter φ of more than π/15 led to poor reconstruction, and therefore good resilience to collusion attacks. Thus, the apparatus of FIG. 3 using a control function in accordance with equation (3) can generate 30 differently phase modulated signals from a single source signal. Using any two differently phase modulated signals to remove a watermark, would not provide acceptable results.

It should be noted that if more than 30 phase modulated signals are required to be generated from a single input signal, other parameters used in equation (3) could be varied. However as described above, these parameters must be changed with care so as to ensure that signal quality is not adversely affected.

It should also be noted that the function of equation (3) is simply exemplarily and other functions can be used. Any such function should be smooth enough to avoid audible frequency distortion.

AAC encoding (in common with other similar encodings) operates on a frame basis. This raises various issues during signal processing which will be known to those of ordinary skill in the art. Although boundary effects can be problematic, they occur only at the beginning and end of the encoded signal, and therefore have only limited impact. However, use of the decoder described above, operating in accordance with equation (2) FIG. 3 will mean that boundary effects appear at the boundary of each frame, thus generating disadvantageous effects every N/2 samples. This potential problem can be overcome using a method as illustrated in FIG. 4.

Here each of the three frames A, B, C has been doubled in length to be N samples long, such that each frame overlaps with another frame. By doing this the first and last samples of each frames need not be used in generation of the reconstructed signal, as is shown in FIG. 4.

In preferred embodiments of the invention, only a small phase modulation is applied, meaning that only a few samples will be affected by boundary effects. For example, using a control signal generated by the control function of equation (3), only (δ+A) samples are affected. Whatever values are selected for X and A, the number of samples affected will be small relative to the length of the frame (typically, N=2048). Appropriate shaping functions can therefore be used to ensure that boundary samples have an almost negligible effect on signal quality. Accordingly, any artefacts introduced by the phase modulation proposed by the invention will have no perceptible effect on signal quality.

The embodiment of the present invention described above incorporates phase modulation into the operation of the IMDCT so as to generate phase modulated signals in which watermarks can be embedded. An alternative embodiment of the invention is shown in FIG. 5. In FIGS. 2, 3 and 5, like reference numerals are used to refer to equivalent components.

Referring to FIG. 5 it can be seen that the illustrated apparatus comprises a decoder 10 which is configured to implement the IMDCT as defined by equation (1) above. The decoder 10 receives a bit stream of AAC data and outputs a decoded signal x, which in turn is input to a watermark embedder 6, which functions as described above. The watermark embedder 6 outputs a signal y which is the signal generated by applying a watermark to the received signal x.

The signal y is then input to a encoder 11. The encoder 11 comprises an MDCT block 12 and a quantizer 13. The encoder 11 receives a control signal generated by a control function 14. The MDCT block 12 is configured to apply the MDCT and additionally to apply phase modulation to the input signal.

The MDCT is defined by equation (4):

$$Y [ k ] = {\sum }_{n = 0}^{N - 1} f [ n ] y [ n ] cos ( \frac{π}{2 N} ( 2 n + 1 + \frac{N}{2} ) ( 2 k + 1 ) ) \qquad ( 4 )$$

where:

$$k = 0 , … , \frac{N}{2} - 1 ;$$

ƒ[n] is an appropriate window function such as that defined with reference to equation (1);

Y is the signal output from the MDCT; and

y is the signal input to the encoder 11 from the watermark embedder 6.

However, the MDCT block 12 is configured to apply the MDCT using modified coefficients such that the resulting reconstructed time signal is a phase modulated version of the originally encoded signal. Accordingly, operation of the MDCT block 12 is represented by equation (5):

$$Y [ k ] = {\sum }_{n = 0}^{N - 1} f [ n ] y [ n - τ [ n ] ] cos ( \frac{π}{2 N} ( 2 n + 1 + \frac{N}{2} ) ( 2 k + 1 ) ) \qquad ( 5 )$$

where:

k, Y, and y are as defined with reference to equation (4); and

τ[n] is a control signal generated by the control function 14 and used to cause phase modulation of the output signal.

It should be noted that τ[n] is a slowly varying function and remains almost constant in within one frame. Thus within a value for the function τ[n] can be replaced with a constant τ.

Now if a variable m is defined as m=n−τ, then equation (5) can be rewritten as:

$$Y [ k ] = {\sum }_{m = - τ}^{N - τ - 1} f [ m + τ ] y [ m ] cos ( \frac{π}{2 N} ( 2 m + 2 τ + 1 + \frac{N}{2} ) ( 2 k + 1 ) ) \qquad ( 6 )$$

The signal Y output from the MDCT block 12 is input to a quantizer 13 configured to generate an output bitstream b_{y}. Operation of the quantizer will be well known to one of ordinary skill in the art.

The embodiment of the invention described above with reference to FIGS. 2 and 3 and equation (2) applies phase modulation within the decoder. The embodiment of the invention described above with reference to FIG. 5 and equations (5) and (6) applies phase modulation within the encoder. It will be appreciated that the phase modulation can be applied by a combination of the decoder and the encoder in some embodiments of the invention.

FIG. 6 shows an alternative embodiment of the present invention based upon that illustrated in FIG. 3. Here, an input bitstream bₓ is again input to the decoder 4. However the decoder 4 includes a further preprocessing module 15 configured to generate data useful for encoding, which is passed directly to the encoder 7 along a line 16. The decoder again comprises a dequantizer 8, and an IMDCT block 9. The preprocessor 5 allows the encoding carried out by the encoder 7 to be carried out more efficiently without the need for optimising bitstream parameters. An implementation of such preprocessing is described in published international patent application WO2004/107316, the contents of which are here incorporated by reference. This document describes a system in which the pre-processor divides a received bitstream into subsignals, passing only the required subsignals to the watermark embedder, the other subsignals being passed directly from the preprocessor to the encoder. It will be appreciated that such a method greatly increases efficiency.

Referring now to FIG. 7, there is illustrated an alternative embodiment of the present invention based upon that shown in FIG. 5. Here, the encoder 11 again comprises an MDCT block 12 and a quantizer 13. However, it can be seen that the quantizer 13 has its operation affected by data received directly from the decoder 16. A Hoffman coding module 17 is also affected by this directly received data. That is, the encoder 11 can encode data more efficiently using the data directly received from the decoder 10.

Although preferred embodiments of the invention have been described above, it will be appreciated that various modifications can be made to these embodiments, without departing from the scope of the attached claims.

The invention is summarized as follows. In watermarking systems, hackers may try to remove the watermark using a so-called collusion attack. If the attacker has access to multiple identical signals with different watermarks (this typically occurs in electronic content delivery systems), simply averaging the signals will remove the watermark energy. A known solution to this problem is phase modulation. By modulating the phase of the signals, the averaging attack will cause phase cancellation to occur and annoying artifacts to be introduced. In the prior art, said phase modulation is carried out in the base-band domain, prior to watermark embedding.

The present invention enables phase modification efficiently to be applied to transform coded signals, in particular DCT or MDCT coded signals such as MP3 or AAC audio signals, or MPEG2 video signals. The bitstream is partially decoded (4) and re-encoded (7). In accordance with the invention, the phase modification is now performed by an appropriately modified version of the forward or inverse (M)DCT transform algorithm (9). The phase modulation is thus an integral part of the decoding process (before watermark embedding) or the encoding process (after watermark embedding), which is very efficient. The phase modulation is controlled by parameters provided by a control function (5).

1. A method for decoding an encoded signal, comprising:
receiving said encoded signal (X); and
decoding said received encoded signal (X) to form a phase modulated decoded signal (x).

2. A method according to claim 1, wherein said decoding comprises:
decoding and transform domain modifying said received encoded signal (X) in an integrated operation (9), to form said phase modulated decoded signal.

3. A method according to claim 1, wherein a control signal is used to control said transform domain modifying of said received encoded signal (X) to form said phase modulated decoded signal (x).

4. A method according to claim 3, further comprising generating a plurality of control signals using a control function (5), each control signal applying a different transform domain modification to the received signal (X) to generate a different phase modulated decoded signal (x).

5. A method according to claim 4, wherein said control function has the form:
τ[n]=δ+A sin(2πfₘn+φ)
where: δ is a constant delay;
A is the amplitude to be associated with the modulation;
fₘ is the frequency to be associated with the modulation; and
φ is the phase shift to be associated with the modulation.

6. A method according to claim 5, wherein a plurality of different control signals are generated by maintaining constant values of δ, A and, fₘ and varying a value of φ.

7. A method according to claim 1 further comprising receiving a digital bit stream data (bₓ), and dequantising said bit stream data to generate said encoded signal (X).

8. A method according to claim 1, further comprising embedding watermark data in said phase modified decoded signal (x).

9. A method according to claim 1, wherein said decoding comprises applying an inverse discrete cosine transform or an inverse modified discrete cosine transform to the received encoded signal (X).

10. A method according to claim 1, further comprising encoding said phase modified decoded signal (y) to generate an encoded signal (y).

11. A method according to claim 10, further comprising preprocessing said received encoded signal (X) to generate intermediate data; and using said intermediate data for said encoding said phase modified decoded signal (y).

12. A computer readable medium carrying computer readable instructions to cause a computer to carry out a method according to claim 1.

13. A computer apparatus for decoding and modifying of an encoded signal, comprising:
a program memory containing processor readable instructions; and
a processor configured to read and execute instructions stored in said program memory;
wherein said processor readable instructions comprise instructions configured to cause the processor to carry out a method according to claim 1.

14. A method for encoding a signal, comprising:
receiving said signal (y); and
encoding said received signal (y) to generate a modified encoded signal (Y), such that decoding of said modified encoded signal (Y) generates a phase modulated version of said signal (y).

15. A method according to claim 14, wherein said encoding comprises:
encoding and modifying said received signal (y) in an integrated operation (12).

16. A method according to claim 15, wherein a control signal is used to control said modifying of said received signal (y).

17. A method according to claim 16, further comprising generating a plurality of control signals using a control function (14), each control signal applying a different modification to the received signal (y).

18. A method according to claim 14, wherein said encoding comprises applying a discrete cosine transform or a modified discrete cosine transform to the received signal (y).

19. A computer readable medium carrying computer readable instructions to cause a computer to carry out a method according to claim 14.

20. A computer apparatus for encoding and phase modulating a signal, comprising:
a program memory containing processor readable instructions; and
a processor configured to read and execute instructions stored in said program memory;
wherein said processor readable instructions comprise instructions configured to cause the processor to carry out a method according to claim 14.

21. Apparatus for decoding an encoded signal, comprising:
means for receiving said encoded signal (X); and
means (9) for decoding said received signal (X) to generate a phase modulated decoded signal (x).

22. Apparatus for encoding a signal, comprising:
means for receiving said signal (y); and
means (12) for encoding said received signal (y) to generate a modified encoded signal (Y) such that decoding of said modified encoded signal (Y) generates a phase modulated version of said signal (y).
